(19) United States
(12) Patent Application Publication
(10) Pub. No.: US 2017/0323271 A1
(43) Pub. Date: Nov. 9, 2017

(54) Systems and Methods for Increasing Users of a Job Listing Service

(71) Applicants: Amin Khaef, Laguna Beach, CA (US); Ramtin Khaef, Laguna Beach, CA (US)

(72) Inventors: Amin Khaef, Laguna Beach, CA (US); Ramtin Khaef, Laguna Beach, CA (US)

(21) Appl. No.: 15/587,723

(22) Filed: May 5, 2017

Related U.S. Application Data
(60) Provisional application No. 62/333,084, filed on May 6, 2016.

(51) Int. Cl. G06Q 10/10; H04L 12/58; G06F 17/30

(52) U.S. Cl. CPC G06Q 10/1053; G06F 17/30867; H04L 51/08

(57) ABSTRACT

Systems and methods for importing information about job opening candidates or employers into a database are provided. Information is extracted from a store of job candidate information and imported into the database. References or contacts, e.g., from letters of recommendation, work history items on a resume, and other documents, may also be imported. Accounts and/or profiles for the imported entities may be created. The imported entities are sent an invitation to use and/or sign up for the system. The imported job applications may be grouped by the job being applied for and each group associated with a particular job listing in the database. The system may automatically create job listings if no association can be made. Job listings may be cross-posted to other job listing services, and information from received resumes/job applications may be imported.

### CROSS-REFERENCE TO RELATED APPLICATIONS

The present application claims benefit of U.S. provisional patent application Ser. No. 62/333,084, titled “Systems and Methods For Importing Job Candidate Information,” filed May 6, 2016, which is incorporated by reference herein in its entirety.

### BACKGROUND

The present disclosure relates generally to software systems and methods for importing information about job opening candidates and/or employers into a database. The present disclosure also pertains to automatically creating accounts and/or profiles for the imported candidates and employers and contacting the imported candidates and employers to inform them of the created account and/or profile information.

The rise of the internet has significantly changed the job search process. Job listing systems, such as indeed.com and monster.com, are now extensively used by both job candidates and employers. Classified ad systems, such as craigslist.org, are also used. However, as social networking systems, these systems need to reach a critical mass of both types of users before being successful. If there aren't enough employers posting job listings in such a system, there is no reason for job candidates to sign up and use the system.

Gaining a critical mass of users can be a long and expensive process for a new system. One barrier is that employers may be reluctant to switch to a new job listing system because that would involve transferring all of their job listings, and information about job candidates that have applied to the listed jobs, to the new system. Therefore, there is a need for a system that can automatically transfer an employer's job listings and job applicants to a new system.

Employers may also not want to lose previous employee sourcing channels that may have a large user base, such as other job posting sites, e.g., indeed.com, monster.com, craigslist.org, etc. There is therefore a need for a system that will allow them to continue sourcing through those channels while getting the benefits of the new system.

There is also a need for a job listing system that fully leverages information about current users and in user email or other accounts to find potential users of the system and help rapid promote growth of the system.

### SUMMARY

In accordance with the foregoing needs and others, methods, systems and apparatuses, including computer programs encoded on computer storage media, are provided for importing information about job opening candidates and/or employers into a database. The embodiments describe a system and method for extracting information about job opening candidates from a list of job applications or other store of job candidate information, and importing the extracted information into a target database.

The system can also be applied to import references or contacts, e.g., from letters of recommendation, work history items on a resume, and other documents, into the target system. The imported entities may be categorized as either other job candidates or as employers.

The system may automatically create accounts and/or profiles for the imported entities, e.g., job candidates and/or employers. The system may also contact the imported entities to invite them to use and/or sign up for the system. Alternatively, the system may insert the imported entities into a database to be contacted manually.

The system may sort and/or group the imported job applications by the job being applied for, and associate each group of imported job applications with a particular job listing in the database. The system may also automatically create job listings if no association can be made.

The system may cross-post job listings to other job listing services, and may automatically import information from received resumes and/or job applications as described above.

The system may include one or more servers, and any number of client devices. The database storing the extracted and imported information may be standalone, or may be located in one of the servers. The database may be a Customer Relationship Management (CRM) system or a user table or collection in a relational or non-relational database. The database or CRM system may be part of a larger job listing service where users, including employers and job candidates, can set up accounts, create job postings, apply for jobs, etc.

One embodiment is directed to a method for importing entity information into a job listing service and contacting the entity, comprising: identifying an entity from a document; identifying contact information for the entity; and sending information about the job listing service using the contact information.

Implementations of this embodiment may include one or more of the following: the document may be a job application or resume, and the method may further comprise the following steps that are performed prior to the step of identifying an entity: receiving access information for a store of job applications or resumes; and accessing the store of job applications or resumes. The store of job application or resumes may be an email account. The contact information may be determined by searching for an email address pattern. The method may further comprise the step of searching the email account for email messages with a from: field matching that of a third-party job listing service. The method may further comprise the step of validating the found email messages by matching content of each email message with an attribute of emails from the third-party job listing service. The method may further comprise the step of grouping the found email messages by job listing. The method may further comprise the step of creating a new job listing in the database when a group of email messages has no corresponding job listing in the database.

Implementations of this embodiment may also include one or more of the following: the document may be an email, and the method may further comprise the following steps that are performed prior to the step of identifying an entity: receiving a job listing into the job listing service; creating an email address; creating a reversible mapping between the received job listing and the email address; posting a crossposted job listing to a separate job listing service, the crossposted job listing including the email address; and receiving the email at the email address.

Implementations of this embodiment may also include one or more of the following: The entity may be a job candidate and the document may be a job application or resume. The entity may be an employer and the document may be a job application or resume. The document may be a letter of reference. The contact information for the entity may be identified from the document. The contact information for the entity may be identified from a third party database. The additional information about the entity may be retrieved from a third party database. The method may further comprise the step of creating a profile for the entity in the database. The method may further comprise the step of creating an account for the entity in the database and the information about the job listing service may comprise an invitation to log in to the created account. The information about the job listing service may comprise a job listing. The information about the job listing service may comprise a job candidate. The invitation may comprise an invitation to sign up with the job listing service.

Another embodiment is directed to a job listing system, comprising: a database comprising employer accounts, job candidate accounts, and job listings; a means for processing comprising a processor and a memory, the memory comprising instructions which, when executed by the processor, perform the steps of: searching an email account for email messages with a from: field matching that of a third party job listing service; identifying information regarding a job candidate from a found email message, wherein the information includes contact information; sending the information regarding the job candidate to the database for creation of an account for the job candidate; and sending, using the contact information, an invitation to log in to the job listing system.

Implementations of this embodiment may include one or more of the following: The processing means may be further adapted to retrieve additional information about the job candidate from a third party database. The processing means may be further adapted to group the found email messages by job listing. The processing means may be further adapted to create a new job listing in the database when a group of email messages has no corresponding job listing in the database.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an embodiment of a system according to the principles of the present disclosure.

FIG. 2 illustrates an embodiment of a method for importing job candidate information according to the principles of the present disclosure.

FIG. 3 illustrates an embodiment of a method for importing job candidate information and employer information according to the principles of the present disclosure.

FIG. 4 illustrates an embodiment of a method for importing job candidate information and/or employer information according to the principles of the present disclosure.

FIG. 5 illustrates an embodiment of a method for automatic posting of job listings and importing job candidate information according to the principles of the present disclosure.

FIG. 6 illustrates an embodiment of a method for automatic posting of job listings and importing job candidate information according to the principles of the present disclosure.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

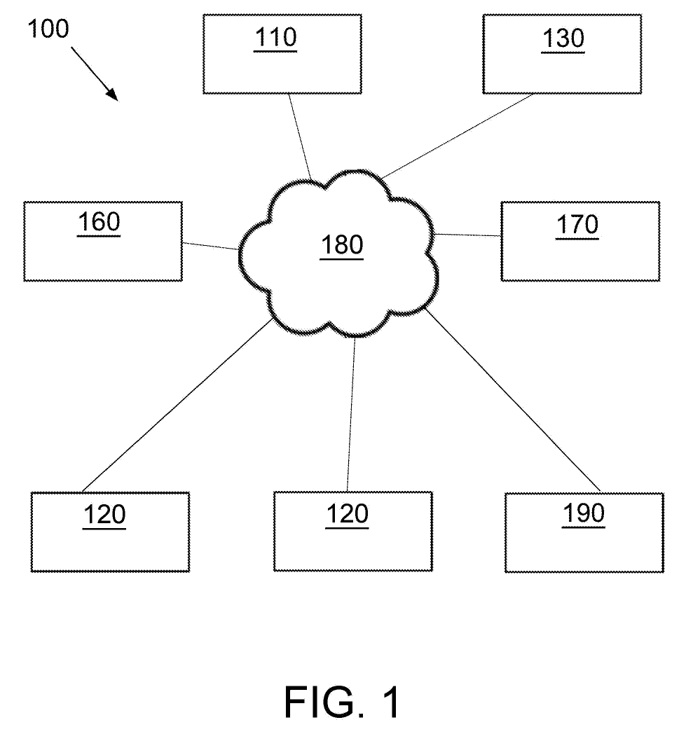

FIG. 1 illustrates one embodiment of a system 100 of the present invention. System 100 may include server 110, database 130, and one or more client devices 120. Server 110, database 130, and client devices 120 communicate through network 180, e.g., the internet, a cloud network, a LAN, a WAN, etc. Client devices 120 can be any type of device capable of communicating with server 110 through network 180, e.g., desktop computers, laptop computers, notebook computers, tablet devices, cellular phones, etc. Server 110 may comprise any device capable of performing one or more of the methods described herein, e.g., a desktop or laptop computer, a server, etc. While server 110 is illustrated as a single device, the functionality of server 110 may be distributed across more than one device. For example, the system 100 may comprise a web server for presenting interfaces and information to client devices 120, an email server for sending emails, etc.

Unless otherwise specified, any step of any of the methods disclosed herein may be performed on the server 110 or a client device 120. Both a traditional client-server architecture, where the majority of the processing is performed on the server, and a more client-centered approach, where the majority of the processing is performed on a client, are within the scope of the present disclosure.

The functionality of the computer application(s) (hereinafter “App”) implementing the steps of the methods disclosed herein can be distributed between the servers and the clients in various ways, as will be described in more detail below. While the application(s) may be referred to as a single “App,” a specific implementation may require several different computer processes, with one or more separate processes running on the server(s), and one or more separate processes running on the clients. The clients may run the client portion of the App as an in-browser component, a stand-alone or installed computer application, a mobile application, a downloadable app, etc. The client portion of the App may also be run via a scripting language such as Javascript. The server may run the server portion of the App as an in-browser component, a stand-alone or installed computer application, a mobile application, a downloadable app, via a scripting language such as Javascript, etc. Note that as used herein, “App” refers to the computer application(s) running on the server(s) and/or client(s), while “application” refers to a job application.

Database 130 can be any type of device capable of storing data and communicating through network 180, e.g., desktop computers, laptop computers, notebook computers, tablet devices, cellular phones, etc. Database 130 stores information regarding the job listing service, e.g., user (employers, job applicants, job candidates, etc.) accounts, entity profiles and/or accounts, job listings, job applications, resumes, mappings between job applicants and job listings (indicating that the applicant has applied to the job listing), etc. An “entity” as used herein refers to a user or a potential user of the system, e.g., employers, job applicants, job candidates, etc., with or without an account. An “account” as used herein refers to the information stored relating to a user who is able to sign into the system, e.g., using a user name and password. A “profile” as used herein refers to the information stored relating to an entity, who may not be able to sign in to the system. In general, a profile will not include a user name and password or other log in information.

Database 130 may be a separate device as shown in FIG. 1, or, in an alternative embodiment, may be part of and/or incorporated into server 110.

The system may also comprise a third-party information source 160, from which additional information about an entity, e.g., a current or prospective user, may be retrieved or queried. The system may also comprise a third-party data analysis device 170, e.g., a third-party resume parser. The system may also comprise a third-party email provider 190, to which the system may gain access in order to search a user's emails.

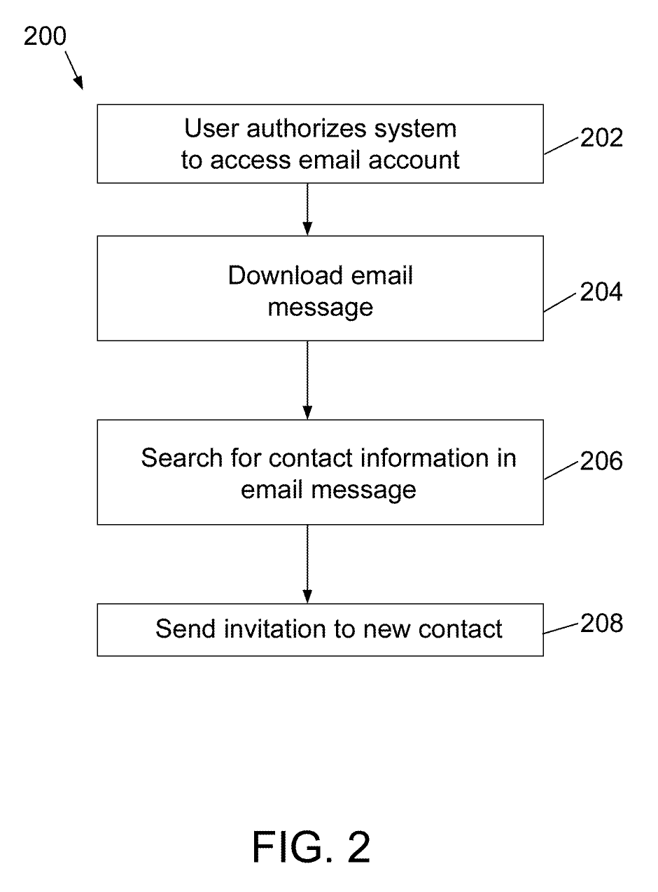

FIG. 2 illustrates a method 200 according to one embodiment. In step 202, the system, e.g., via a client App, receives input from a user, e.g., an employer, that will enable the system to read messages from the user's email server or other store of job applications or resumes. In one embodiment, the user may input user credentials, e.g., username and password, for use with traditional email services such as IMAP, POP, and SMTP. The user may instead be referred to a third-party authorization technology using authentication tokens, e.g., OAuth, eliminating the need for the user to supply their username and password.

Also, instead of using a traditional email service, an email API such as GMail or Outlook may be used. This may require third-party authorization, and also may enable more searching, categorization, and sending capabilities.

In an alternative embodiment, the user can directly supply the email messages to the system.

This step can be performed either in a server-side component of the system, with an authorization token or user credentials being passed to the server. Alternatively, this step can be performed entirely on the client, either in-browser, via a scripting language such as javascript, or as a mobile App or other installed App.

In step 204, the system accesses the email account using the authorization token or user credentials, and downloads an email message. The email message may include one or more of the following fields: sender, subject, body, attachment, from email address, and to email address. The downloaded fields may be saved to a volatile area such as RAM, or in a permanent form, such as on-disk, in nonvolatile memory, on a cookie, on a file- or database-server, or on a cloud storage area such as Amazon S3. The downloaded fields may also be stored in database 130.

This step may again be performed client-side or server-side, or as a combination, with the interaction with the mail API on one side and the storage of information on the other side.

In step 206, the system searches for a contact address, e.g., an email address, phone number, etc., in the email message. This may be performed by searching for a pattern that matches a contact address. Other information about the contact, e.g., name, etc., may also be searched for.

For example, to match an email address, the system can search for:
one or more alpha, numeric, period, underscore, percentage, plus, or minus characters
. . . directly followed by . . .
an ‘@’ symbol
. . . directly followed by . . .
one or more alphanumeric, dash, or ‘.’ characters
. . . directly followed by . . .
a ‘.’ symbol
. . . directly followed by . . .
two or more alpha characters

In step 208, the system sends an invitation to the contact address found in step 206. The invitation may be an invitation to try the job listing service or join the job listing service, either directly (e.g., via email, text message, etc.), or by storing the contact address in database 130 enabling manual human contact.

This step can be automatic or semi-automatic, i.e., allowing for human intervention. For example, once the contact address has been gathered, it can be inserted into a task in a CRM for a staff member to perform the contact task. The contact task, either automatic or semi-automatic, may be queued for a later time.

In one embodiment, the system may contact the newly found contact using the user's email account, either on behalf of the user or on behalf of the job listing service.

In addition, an account and/or profile for the new contact may be automatically created in the job listing service using any of the information obtained in the previous step.

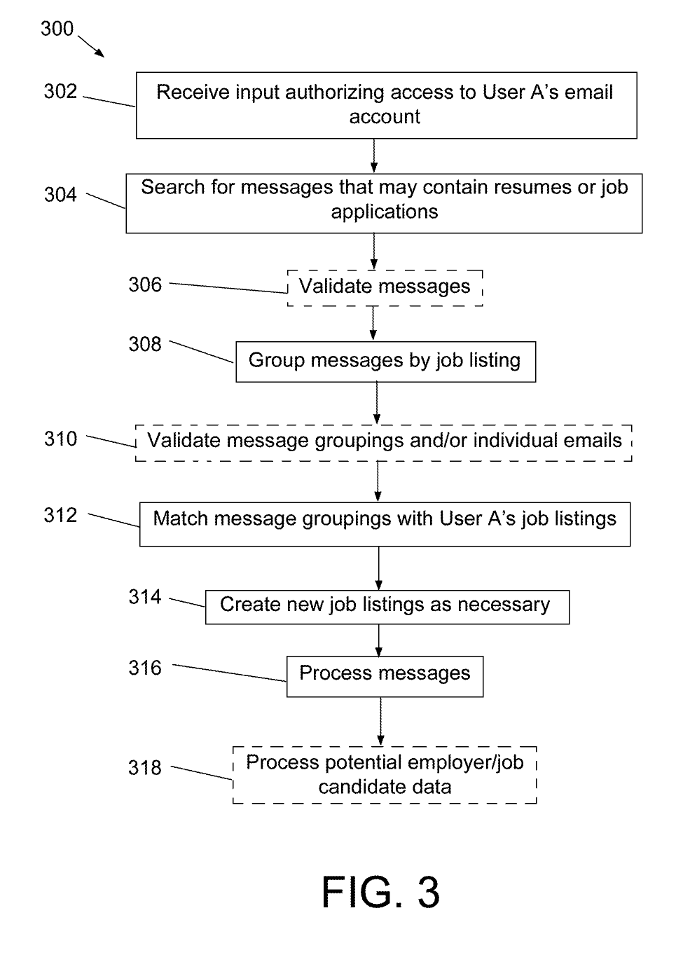

FIG. 3 illustrates a method 300 according to one embodiment. In step 302, the system receives input from User A, e.g., an employer with an account on the job listing service, that will enable the system to read messages from the user's email server or other store of job applications or resumes. In one embodiment, the user may input user credentials, e.g., username and password, for use with traditional email services such as IMAP, POP, and SMTP. The user may instead be referred to a third-party authorization technology using authentication tokens, e.g., OAuth, eliminating the need for the user to supply their username and password.

Also, instead of using a traditional email service, an email API such as Gmail, Microsoft 365, or Outlook may be used. This may require third-party authorization, and also may enable more searching, categorization, and sending capabilities.

If the system uses a third-party authorization service, User A is then directed to the third-party authorization provider corresponding to the selection in the previous step, such as OAuth2. The provider prompts User A for their login information, and after authenticating the user, prompts the user if the user would like to authorize the referring App to read their messages, organize their messages (using tags, folders, labels, or whatever means the email service provides), and send messages on their behalf. If User A has previously been authenticated by the provider, that step may be skipped. If User A authorizes the App, the authorization token may be sent to the App.

This step can be performed either in a server-side component of the system, with an authorization token or user credentials being passed to the server. Alternatively, this step can be performed entirely on the client, either in-browser, via a scripting language such as javascript, or as a mobile App or other installed App.

In step 304, the system searches for messages in User A's email account that may contain resumes or job application. These can be identified, e.g., from sender addresses whose domains are known to send resumes or applications, such as those of other job board domains. For example, emails from job listing services, e.g., craigslist.org, indeed.com, careerbuilder.com, dice.com, glassdoor.com, monster.com, etc., may be identified as possibly relevant emails.

In an alternative embodiment, the user can directly supply the email messages to be searched. In a further alternative embodiment, User A may indicate that all messages supplied by the user or in the email account are dedicated to job candidate applications, so no searching need be performed.

In optional step 306, the messages matching the criteria in step 304 are validated to ensure that the messages contain valid job application information or resumes from job candidates. The validation is performed by verifying whether there is an attachment or if a search pattern is matched in the body of the email. For example, one or more of the following identifiers may be used to identify an email as a response to a craigslist.com job posting:
The message body contains “Original craigslist post”;
The message body contains a link to a path within either craigslist.org or a subdomain of craigslist.org;
The message body contains any of the other static text found in the craigslist.com signature;
The from: address contains “craigslist.org”;
The to: address contains “craigslist.org”;
There is an attachment with an extension that's associated with a document, e.g, “.doc”, “.docx”, “.pdf”, etc.;
There is an attachment with an extension that's associated with a document, e.g, “.doc”, “.docx”, “.pdf”, etc., and the attachment parses well as a resume;
The existence of the letters “craig” anywhere in the email body, subject, or headers;
Finding any text in the email body, subject, or headers that matches the craigslist job categories, e.g., “/hea/” or “hea” for medical/health, “/fbh/” or “fbh” for food beverage hospitality, etc. The full list can be found at craigslist.org;
Finding any of the words “resume”, “application”, “CV”, “apply”, etc., in the email body, subject, or attachments;
Finding HTML source code structure matching that of craigslist's emails;
Finding CraigslistMail in the email raw text;

As another example, one or more of the following identifiers may be used to identify an email as a response to an indeed.com posting:
The subject line includes “applied on Indeed” (case insensitive);
The subject line or message body includes “candidate”;
The message body includes “applied for your”;
The message body includes “job in”;
The message body includes a link to a path within either indeed.com or any subdomain of indeed.com;
The message body, header, or subject line has the string “indeed” in it;
The message body contains anything else in indeed.com's email signature;
The email contains the indeed logo, as can be determined if the source code of the email contains “logo” or “Indeed Logo” or “indeed-logo”;
The email contains the manage on indeed logo as can be determined if the source code of the email contains an <a> element that contains the following: the text “Manage on” and a <span> element with the word “Indeed” in it;
The message body contains any of the strings “schedule”, “interview”, “reject”, or “candidate”;
There is an attachment with an extension that's associated with a document, e.g, “.doc”, “.docx”, “.pdf”, etc.;
There is an attachment with an extension that's associated with a document, e.g, “.doc”, “.docx”, “.pdf”, etc., and the attachment parses well as a resume;

In step 308, the list of messages identified in step 304 (and possibly filtered by step 306) is grouped by indications corresponding to specific job listings that were made by User A. For example, a portion of the subject line or the from: or to: addresses can be used as a grouping method. Craigslist's anonymizer uses the same “to:” address for all job applications sent for a given job posting, e.g., for the “to:” address qrcqp-1234567890@job.craigslist.org, “qrcqp-1234567890” refers to the specific job posting at the url “http://losangeles.craigslist.org.lac.hea/1234567890.html.” Note that the numbers in the “to:” address and the original posting match.

Another grouping method can use a token within the message body indicating a common job listing. Craigslist shows the link for the original post toward the end of the message body, which includes the numbers shown above, and which can uniquely group the original job listing. With respect to emails in response to job listings on indeed.com, these emails often contain the phrase “applied for your [Job Title] job in [Location].” The Job Title and Location fields may be extracted and used to group emails.

Yet another grouping method can use the subject line, which often indicates the title of the job.

Step 308 can be swapped with step 306.

In optional step 310, User A (or a different user, e.g., an employee or contractor of the job listing service, etc.) is presented with a list of job listing groupings determined in step 308. This may also include how many applications were found for each job listing and/or a date range of matched emails for each job listing. User A may be given an opportunity, e.g., through checkboxes or another user interface element, to select or deselect any of the job groupings determined in step 310. Alternately, or in addition, User A may be given the opportunity, e.g., through checkboxes or another user interface element, to select or deselect individual email messages found within each job grouping. Server 110 may send the list to client device 120 for presentation to the user, or the list may be presented to the user on server 110.

In step 312, a determination is made regarding how each job listing group determined in step 308 maps to User A's job listings in the job listing service. A search may be performed against database 130 returning all job listings stored for User A. After User A's job listings have been retrieved, keywords from the emails comprising the job listing groups are automatically determined, e.g., via content analysis, natural language processing, etc. Keywords from the job listings are also determined. The job listing keywords may have been previously entered by, e.g., User A, or may be automatically determined in a similar manner as keywords from the emails in the job listing groups.

After the job listing keywords and the email keywords have been determined, the keywords are compared to determine the best match between job listings and job listing groups. For example, given a particular job listing group to be matched with a job listing, a normalized frequency of keyword matches between the job listing group and each job listing may be determined. Then the job listing that ranks highest will be selected as the match for that job listing group.

As a more detailed example, User A has two job listings, one for a waiter/waitress and one for an executive assistant. The waiter/waitress job may have associated keywords such as “waitstaff,” “server,” “waitress,” “waiter,” etc. The administrative assistant may have associated keywords such as “administrative,” “secretary,” etc. If a particular job listing group has a normalized frequency of keyword matches with respect to the waiter/waitress listing of 5, and a normalized frequency of keyword matches with respect to the administrative assistant listing of 1, the system would match the job listing group with the waiter/waitress listing.

Alternatively or additionally, this determination may be made with input from the user. For each job listing group presented in step 310, a dropdown box or other user interface element can also be presented with options comprising User's A's job listings in the job listing service, enabling User A to select with job listing corresponds to each job listing group. An additional option can be presented to User A indicating that a new job listing can be programmatically created in database 130 based on that grouping. The default selection in each dropdown may be the job listing automatically determined by the system.

Any determined mappings are stored in database 130 or other memory. Also, any job listing group for which a mapping cannot be determined is added to a list of job listings that need to be created in User A's account on the job listing service. If User A doesn't have any job listings in the job listing service, then all job listing groups are added to the list.

In step 314, any job listings that need to be created in User A's account are created.

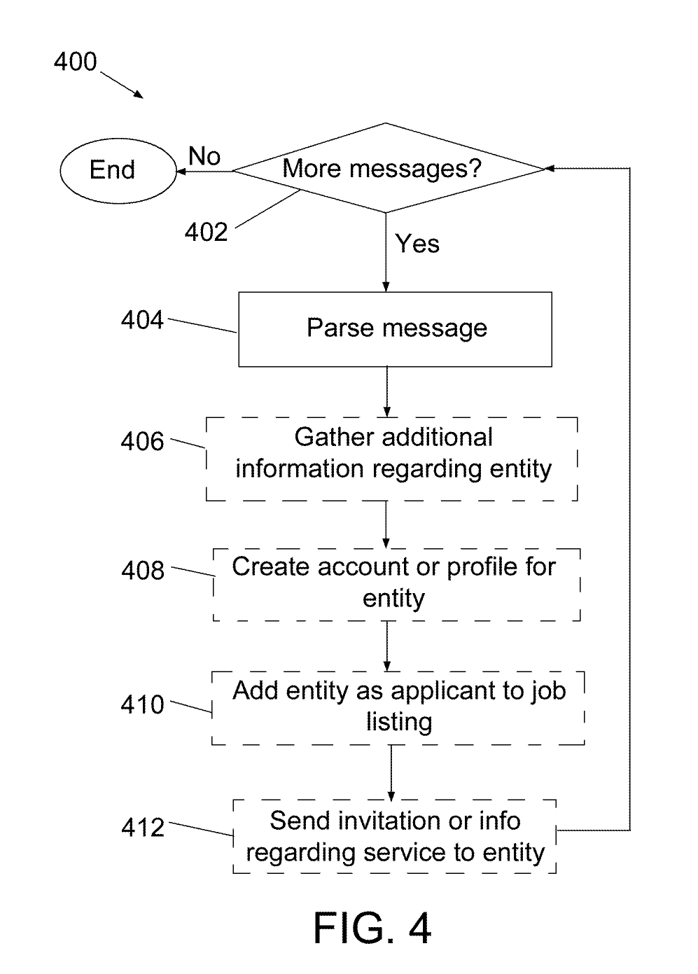

In step 316, the messages corresponding to a job application or resume identified in step 304 (and possibly filtered by step 306) are processed. This step is described in more detail below with respect to FIG. 4.

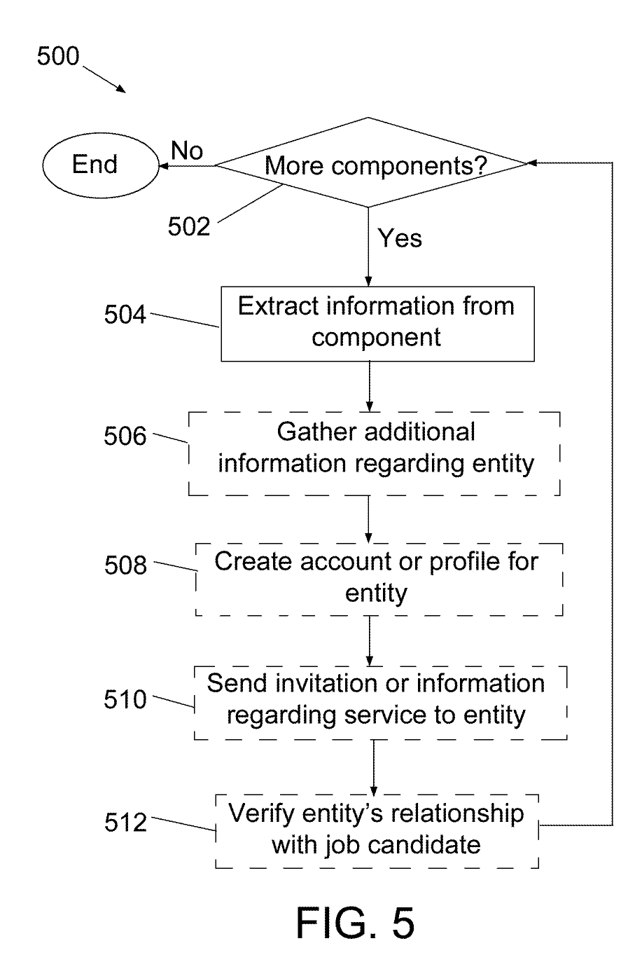

In optional step 318, the system processes the data obtained in step 316 that may contain information about another potential employer or job candidate user or a means of acquiring those, such as employment history items, letters of recommendations, references, and education history items contained in resumes. This step is described in more detail below with respect to FIG. 5.

FIG. 4 illustrates a method 400 for processing messages according to one embodiment. In step 402, the system determines if there are any remaining messages that may contain a job application or resume, such as those that may be obtained above in step 304 (and optionally filtered by step 306). If so, one of the remaining messages is selected, and the method proceeds to step 404. If not, the method ends.

In step 404, the system searches the candidate's (deemed Entity B going forward) resume or application data contained in the selected email message, extracting relevant employment-, education-, and/or contact-related information. For example, an email address can be searched for as described above with respect to step 206 of FIG. 2.

In addition or alternatively, a resume or job application-specific parsing technology, either in-house or an outside service, may be used. For example, resumes and job applications generally use headings such as Education, Work Experience/Experience, Skills, and References. The parser can identify these headings, then categorize the information under each heading as belonging to that category of information. The parser may gather any or all of the following: work history information, education information, skill information, name, address, languages, career, references, or anything else a job application or resume would include. The resume or job application data may also be stored for later categorization of the information therein. These resume and job application components may be used in the method 500 illustrated in FIG. 5 to find other potential users of the job listing service.

OCR technology may be used in this step to enable the processing of images, pdfs, and/or scanned documents that are attached to the message or job application.

In optional step 406, additional information may be gathered about Entity B by querying against people search databases, professional networks such as LinkedIn, white pages, sex offender databases, professional networks, criminal record checks, social networks, or any other databases that contain information about people or businesses.

In addition, information may be retrieved from other sources of information, such asking for completion from Entity B, asking for completion from a previous employer or professional contact (e.g., a reference in a resume or job application) of Entity B, etc.

If no contact information was found, either in this step or the previous step, additional searches may be performed to find the contact information. For example, if the business name of a contact is found, a google maps API search can be performed using the business name to find the business's phone number. As another example, a LinkedIn profile can be searched using a found personal or business name to find an email address.

In optional step 408, an account and/or profile is created for Entity B on the job listing service using any of the information obtained in the previous steps. Alternatively, Entity B's information may be stored in database 130 or other memory, e.g., a potential user table or file, for later conversion to an account.

In optional step 410, Entity B may be added as an applicant to the job that the mapping of step 312 determined.

In optional step 412, Entity B is sent an invitation to join and/or log in to the job listing service via email, text, phone call, or other means. The email, phone number, or other contact information of Entity B may have been obtained in step 404 or step 406. Entity B may also be sent a means to log in to the job listing service, such as a username/email and password automatically generated for Entity B, or a one-time login link. The login destination can be either to manage the user's account and/or profile or to review their application to User A's job.

The invitation may include information about the job listing service. If Entity B's location is known, the invitation may include information about job listings within a predefined distance of Entity B's location. The job listing may be filtered to only include listings with keywords that match Entity B's information. A match between a job listing and Entity B's information may be determined, e.g., via a keyword match (as described above with respect to step 312 of method 300) between the job listing and Entity B's information, and/or a keyword match between the job listing and other job listings Entity B has applied to.

Alternatively, Entity B's contact information (e.g., email, phone number, etc.) may be stored in database 130 enabling manual human contact at a later time.

In one embodiment, the system may send an email to Entity B using User A's email account, so the invitation email will look like it came from User A. Alternatively, the system may email Entity B using a dedicated email address.

In addition or alternatively, an email may be sent to an employer user (different from User A), that may be interested in Entity B, informing the employer user about Entity B. For example, if the employer has a job listing that matches Entity B's profile and/or account information, and Entity B is located within a predefined distance of the employer, the employer may be determined by the system to be interested. A match between a job listing and Entity B's information may be determined, e.g., via a keyword match (as described above with respect to step 312 of method 300) between the job listing and Entity B's information, and/or a keyword match between the job listing and other job listings Entity B has applied to.

The method then returns to step 402.

FIG. 5 illustrates a method 500 for processing resume or job application components according to one embodiment. In step 502, the system determines if all of the job application and/or resume components that may contain information about another potential user or a means of acquiring such, such as employment/work history items, letters of recommendations, references, and/or education history items, have been processed. These may have been obtained above in step 404, or a user may directly upload the employment/work history items, letters of recommendations, references, and/or education history items. A user may also upload or reference a resume or a profile of a professional network, e.g., LinkedIn, from which these items may be extracted as described above with respect to step 404 of FIG. 4.

If there are remaining components to be processed, one of the remaining components is selected and the method proceeds to step 504. If not, the method ends.

In step 504, as much of the contact, company, or personal information as can be extracted about the potential employer user or candidate user (deemed Entity C going forward) is extracted from the selected component. The system determines the contact or other information through direct analysis of the selected component, e.g., via natural language processing, internal content analysis, a third-party resume parser, etc. Missing or incorrect information may be manually entered.

In optional step 506, incomplete or additional information regarding Entity C is obtained by searching business listing directories, local search engines, lead databases, google maps, or any of the other channels referred to in step 406 of FIG. 4. This information may include company information, business type, location, and potential job openings.

In optional step 508, an account and/or profile is created for Entity C on the job listing service using any of the information obtained in the previous steps.

In optional step 510, Entity C is sent information about and/or an invitation to join or log in to the job listing service, as described above with respect to step 412 of FIG. 4.

In optional step 512, Entity C is requested to verify their relationship with Entity B (the contact whose resume and/or job application was used in find Entity C), such as verifying a work history entry, a letter of recommendation, etc.

The method then returns to step 502.

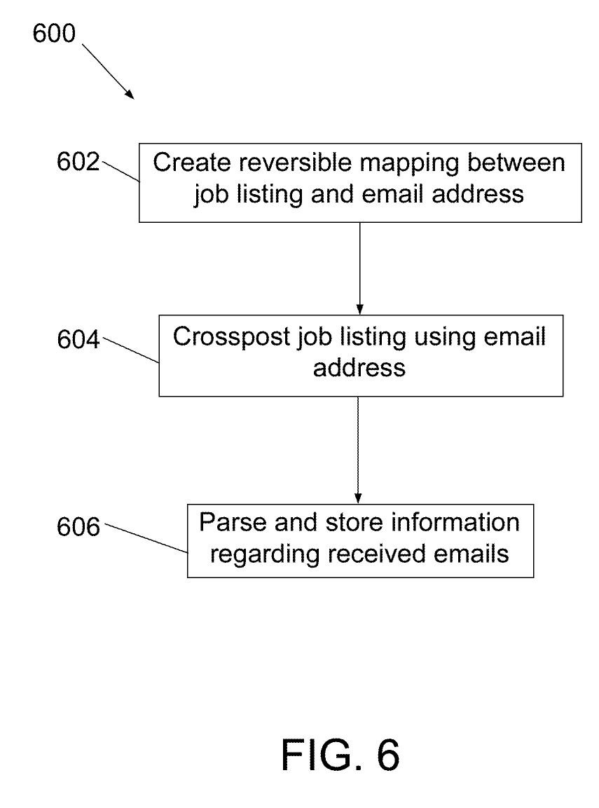

FIG. 6 illustrates a method 600 for automatically posting job listings according to one embodiment. In step 602, a user, e.g., an employer, posts a job listing to the job listing service and a reversible mapping is created between the job listing and an email address. The email address may be created by combining the following: a prefix, such as the word “job” or the employer's user name, possibly followed by a dash; a unique database key corresponding to the job listing; and a suffix, e.g., @domainname.com. For example, if “employer”'s job listing with a database key of “3” is being cross-posted, the email address “employer-3 @domainname.com” may be used. domainname.com may be the domain name of the job listing service. Alternatively, domainname.com may be changed over time or selected from a predetermined pool of domain names to combat potential blocking of the domain name by the separate job listing site. Variations of the above will be apparent to one of ordinary skill in the art. An email account is created in the system using created email address.

In step 604, the job listing is cross-posted to a separate job listing website, such as craigslist.org, using the email address created in step 602 as the email address to which responses to the job listing on the separate job website will be sent.

In step 606, when the system receives an email at the email address created in step 602, the information in the email is parsed and stored, and the newly identified user is sent an invitation, as described in steps 404 through 412 of the method 400 described in FIG. 4. The new user identified in the email message may be added as a job applicant to the job listing corresponding to the email address to which the email was sent.

The receiving email server my use a catch-all email address or automatic email forwarder so all emails are received in the same email box. Alternatively, the receiving email server may have a separate mailbox for each mapped email address.

In an alternative embodiment of method 600, a job title, instead of an email address, may be created for each job listing. In this embodiment, a reversible mapping is created between the job listing and the created job title. The job title is then used in the cross-posting, and a general email address associated with the system is used as the email address to which responses to the job listing on the separate job website will be sent. When emails are received at the general email address, the job postings to which they correspond are identified by the job title.

The embodiments disclosed herein allow for rapid user growth of a job listing system. For each employer that joins, many job candidate users may be sent invitations. Additionally, job candidate users also provide the system with many potential additional employers, which can be obtained from their resume or job application details, such as previous work experience, references, and letter of recommendations.

While the above methods have generally been directed towards accessing an email account holding job applications and/or resumes, other stores of job applications and/or resumes may also be used, e.g., a database, a list of files, scanned paper documents, etc.

Unless specifically stated otherwise, as apparent from the following discussion, it is appreciated that throughout the description, discussions utilizing terms such as “processing” or “computing” or “calculating” or “determining” or “displaying” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

Embodiments of the subject matter and the functional operations described in this specification can be implemented in one or more of the following: digital electronic circuitry; tangibly-embodied computer software or firmware; computer hardware, including the structures disclosed in this specification and their structural equivalents; and combinations thereof. Such embodiments can be implemented as one or more modules of computer program instructions encoded on a tangible non-transitory program carrier for execution by, or to control the operation of, data processing apparatus (i.e., one or more computer programs). Program instructions may be, alternatively or additionally, encoded on an artificially generated propagated signal (e.g., a machine-generated electrical, optical, or electromagnetic signal) that is generated to encode information for transmission to suitable receiver apparatus for execution by a data processing apparatus. And the computer storage medium can be one or more of: a machine-readable storage device, a machine-readable storage substrate, a random or serial access memory device, and combinations thereof.

As used herein, the term “data processing apparatus” comprises all kinds of apparatuses, devices, and machines for processing data, including but not limited to, a programmable processor, a computer, and/or multiple processors or computers. Exemplary apparatuses may include special purpose logic circuitry, such as a field programmable gate array (“FPGA”) and/or an application specific integrated circuit (“ASIC”). In addition to hardware, exemplary apparatuses may comprise code that creates an execution environment for the computer program (e.g., code that constitutes one or more of: processor firmware, a protocol stack, a database management system, an operating system, and a combination thereof).

The term “computer program” may also be referred to or described herein as a “program,” “software,” a “software application,” a “module,” a “software module,” a “script,” or simply as “code.” A computer program may be written in any form of programming language, including compiled or interpreted languages, or declarative or procedural languages, and it can be deployed in any form, including as a standalone program or as a module, component, subroutine, or other unit suitable for use in a computing environment. Such software may correspond to a file in a file system. A program can be stored in a portion of a file that holds other programs or data. For example, a program may include one or more scripts stored in a markup language document; in a single file dedicated to the program in question; or in multiple coordinated files (e.g., files that store one or more modules, sub programs, or portions of code). A computer program can be deployed and/or executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as but not limited to an FPGA and/or an ASIC.

Computers suitable for the execution of the one or more computer programs include, but are not limited to, general purpose microprocessors, special purpose microprocessors, and/or any other kind of central processing unit (“CPU”). Generally, CPU will receive instructions and data from a read only memory (“ROM”) and/or a random access memory (“RAM”). The essential elements of a computer are a CPU for performing or executing instructions and one or more memory devices for storing instructions and data. Generally, a computer will also include, or be operatively coupled to receive data from or transfer data to, or both, one or more mass storage devices for storing data (e.g., magnetic, magneto optical disks, and/or optical disks). However, a computer need not have such devices. Moreover, a computer may be embedded in another device, such as but not limited to, a mobile telephone, a personal digital assistant (“PDA”), a mobile audio or video player, a game console, a Global Positioning System (“GPS”) receiver, or a portable storage device (e.g., a universal serial bus (“USB”) flash drive).

Computer readable media suitable for storing computer program instructions and data include all forms of nonvolatile memory, media and memory devices. For example, computer readable media may include one or more of the following: semiconductor memory devices, such as erasable programmable read-only memory (“EPROM”), electrically erasable programmable read-only memory (“EEPROM”) and/or and flash memory devices; magnetic disks, such as internal hard disks or removable disks; magneto optical disks; and/or CD-ROM and DVD-ROM disks. The processor and the memory can be supplemented by, or incorporated in, special purpose logic circuitry.

To provide for interaction with a user, embodiments may be implemented on a computer having any type of display device for displaying information to a user. Exemplary display devices include, but are not limited to one or more of: projectors, cathode ray tube (“CRT”) monitors, liquid crystal displays (“LCD”), light-emitting diode (“LED”) monitors and/or organic light-emitting diode (“OLED”) monitors. The computer may further comprise one or more input devices by which the user can provide input to the computer. Input devices may comprise one or more of: keyboards, a pointing device (e.g., a mouse or a trackball). Input from the user can be received in any form, including acoustic, speech, or tactile input. Moreover, feedback may be provided to the user via any form of sensory feedback (e.g., visual feedback, auditory feedback, or tactile feedback). A computer can interact with a user by sending documents to and receiving documents from a device that is used by the user (e.g., by sending web pages to a web browser on a user's client device in response to requests received from the web browser).

Embodiments of the subject matter described in this specification can be implemented in a computing system that includes one or more of the following components: a backend component (e.g., a data server); a middleware component (e.g., an application server); a front end component (e.g., a client computer having a graphical user interface (“GUI”) and/or a web browser through which a user can interact with an implementation of the subject matter described in this specification); and/or combinations thereof. The components of the system can be interconnected by any form or medium of digital data communication, such as but not limited to, a communication network. Non-limiting examples of communication networks include a local area network (“LAN”) and a wide area network (“WAN”), e.g., the Internet.

The computing system may include clients and/or servers. The client and server may be remote from each other and interact through a communication network. The relationship of client and server arises by virtue of computer programs running on the respective computers and having a client-server relationship to each other.

Various embodiments are described in this specification, with reference to the detailed discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those skilled in the art, and such modifications are also intended to fall within the scope of the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

All references including patents, patent applications and publications cited herein are incorporated herein by reference in their entirety and for all purposes to the same extent as if each individual publication or patent or patent application was specifically and individually indicated to be incorporated by reference in its entirety for all purposes.

What is claimed is:

1. A method for importing entity information into a job listing service and contacting the entity, comprising:
identifying an entity from a document;
identifying contact information for the entity; and
sending information about the job listing service using the contact information.

2. The method of claim 1, wherein the document is a job application or resume, further comprising the following steps that are performed prior to the step of identifying an entity:
receiving access information for a store of job applications or resumes; and
accessing the store of job applications or resumes.

3. The method of claim 2, wherein the store of job application or resumes is an email account.

4. The method of claim 3, wherein the contact information is determined by searching for an email address pattern.

5. The method of claim 3, further comprising the step of searching the email account for email messages with a from: field matching that of a third-party job listing service.

6. The method of claim 5, further comprising the step of validating the found email messages by matching content of each email message with an attribute of emails from the third-party job listing service.

7. The method of claim 5, further comprising the step of grouping the found email messages by job listing.

8. The method of claim 7, further comprising the step of creating a new job listing in the database when a group of email messages has no corresponding job listing in the database.

9. The method of claim 1, wherein the document is an email, further comprising the following steps that are performed prior to the step of identifying an entity:
receiving a job listing into the job listing service;
creating an email address;
creating a reversible mapping between the received job listing and the email address;
posting a crossposted job listing to a separate job listing service, the crossposted job listing including the email address; and
receiving the email at the email address.

10. The method of claim 1, wherein the entity is a job candidate and the document is a job application or resume.

11. The method of claim 1, wherein the entity is an employer and the document is a job application or resume.

12. The method of claim 1, wherein the document is a letter of reference.

13. The method of claim 1, wherein the contact information for the entity is identified from the document.

14. The method of claim 1, wherein the contact information for the entity is identified from a third party database.

15. The method of claim 13, wherein additional information about the entity is retrieved from a third party database.

16. The method of claim 1, further comprising the step of creating a profile for the entity in the database.

17. The method of claim 1, further comprising the step of creating an account for the entity in the database and wherein the information about the job listing service comprises an invitation to log in to the created account.

18. The method of claim 1, wherein the information about the job listing service comprises a job listing.

19. The method of claim 1, wherein the information about the job listing service comprises a job candidate.

20. The method of claim 1, wherein the invitation comprises an invitation to sign up with the job listing service.

21. A computer-readable medium comprising instructions for implementing the method of claim 1.

22. A job listing system, comprising:
a database comprising employer accounts, job candidate accounts, and job listings;
a means for processing comprising a processor and a memory, the memory comprising instructions which, when executed by the processor, perform the steps of:
searching an email account for email messages with a from: field matching that of a third party job listing service;
identifying information regarding a job candidate from a found email message, wherein the information includes contact information;
sending the information regarding the job candidate to the database for creation of an account for the job candidate; and
sending, using the contact information, an invitation to log in to the job listing system.

23. The job listing system of claim 22, wherein the processing means is further adapted to retrieve additional information about the job candidate from a third party database.

24. The job listing system of claim 22, wherein the processing means is further adapted to group the found email messages by job listing.

25. The job listing system of claim 24, wherein the processing means is further adapted to send information regarding the creation of a new job listing to the database when a group of email messages has no corresponding job listing in the database.
